(19) United States
(12) Patent Application Publication
(10) Pub. No.: US 2018/0105691 A1
(43) Pub. Date: Apr. 19, 2018

(54) PELLET AND METHOD FOR PRODUCING THE SAME

(71) Applicant: ASAHI KASEI KABUSHIKI KAISHA, Tokyo (JP)

(72) Inventor: Nozomi INAGAKI, Tokyo (JP)

(73) Assignee: ASAHI KASEI KABUSHIKI KAISHA, Tokyo (JP)

(21) Appl. No.: 15/455,421

(22) Filed: Mar. 10, 2017

(30) Foreign Application Priority Data
Oct. 19, 2016 (JP) 2016-205212

(51) Int. Cl. C08L 71/12; B29B 9/06

(52) U.S. Cl. CPC C08L 71/123; B29B 9/06; B29K 2071/12; C08L 2205/14; C08L 2205/03

(57) ABSTRACT

This disclosure is to provide a pellet excellent in modification effect of heat-resistant creeping property improvement of thermoplastic resins such as polyethylene and the like, and excellent in appearance as well. The pellet of this disclosure contains: 60 to 99 mass % of a polyphenylene ether resin (I); and 1 to 40 mass % of a block copolymer (II), which contains a polymer block P mainly formed of a vinyl aromatic compound, and a polymer block Q mainly formed of a conjugated diene compound of which a total amount of 1,2-vinyl bonding amount and 3,4-vinyl bonding amount is 5% or more and less than 50%, wherein: black spot foreign matters with a longitudinal diameter of more than 0.7 mm do not exist on front and back surfaces of a flat plate obtained by molding the pellet into four flat plates with a size of 90.0 mm×50.0 mm×2.0 mm.

### TECHNICAL FIELD

This disclosure relates to a pellet and a method for producing the same.

### BACKGROUND

Polyethylene is excellent in cold resistance, electrical performances, low specific gravity, etc., and thus is a general-purpose resin widely used in various containers, films, pipes, miscellaneous goods, and other industrial products. However, due to its low heat resistance, the performances at high temperature environment are poor, and its usage environment is limited when used alone.

PTL1 discloses a technique for improving mechanical strength such as melt strength, dart impact or other, by adding modifiers having branched structures into polyethylene, but does not disclose a technique relating to performance modification at high temperature environment. Therefore, solutions to the problems of conventional polyethylene have not been discovered presently.

### CITATION LIST

### Patent Literature

PTL1: JP5960831B2

PTL2: JP5622905B2

### SUMMARY

In some cases, in order to obtain a modifier for modifying resins such as polyethylene and the like, a polyphenylene ether is desired to be contained in other resins at a high concentration. However, when producing a composition comprising a polyphenylene ether at a high concentration, there were problems such as generation of black spot foreign matters derived from the polyphenylene ether, and deterioration of production efficiency.

PTL2 discloses a resin composition containing a polyphenylene ether at a low concentration, which is excellent in appearance and production efficiency, but has not studied the case of polyphenylene ether at a high concentration.

This disclosure is made regarding such technical problems, and provides a pellet excellent in modification effect of heat-resistant creeping property improvement of thermoplastic resins such as polyethylene and the like, and excellent in appearance as well. Moreover, this disclosure provides a method for efficiently producing a pellet excellent in modification effect of heat-resistant creeping property improvement of thermoplastic resins such as polyethylene and the like, and excellent in appearance as well.

Having intensively studied solutions to the aforementioned problems, we discovered that pellets, which comprise a polyphenylene ether and a block copolymer with a specific structure, and contain black spot foreign matters less than a specific amount in the flat plate obtained by molding the pellet, are capable of beneficially solving the aforementioned problems, and thereby accomplished this disclosure.

Namely, this disclosure is as follows.

[1] A pellet comprising:

60 to 99 mass % of a polyphenylene ether resin (I); and

1 to 40 mass % of a block copolymer (II), which comprises a polymer block P mainly comprising a vinyl aromatic compound, and a polymer block Q mainly comprising a conjugated diene compound of which a total amount of 1,2-vinyl bonding amount and 3,4-vinyl bonding amount is 5% or more and less than 50%, wherein:

black spot foreign matters with a longitudinal diameter of more than 0.7 mm do not exist on front and back surfaces of four flat plates obtained by molding the pellet into the flat plates with a size of 90.0 mm×50.0mm×2.0 mm.

[2] The pellet according to [1], wherein: on front and back surfaces of the four flat plates, a number of observed black spot foreign matters with a longitudinal diameter of more than 0.5 mm and 0.7 mm or less is 5 or less.

[3] The pellet according to [1] or [2], wherein: on front and back surfaces of the four flat plates, a number of observed black spot foreign matters with a longitudinal diameter of more than 0.3 mm and 0.5 mm or less is 10 or less.

[4] The pellet according to any one of [1] to [3], comprising:

80 to 99 mass % of the polyphenylene ether resin (I); and

1 to 20 mass % of the block copolymer (II).

[5] The pellet according to any one of [1] to [4], wherein: a number average molecular weight of the polymer block P is 15,000 or more.

[6] The pellet according to any one of [1] to [5], wherein: the total amount of 1,2-vinyl bonding amount and 3,4-vinyl bonding amount of the conjugated diene compound in the polymer block Q is 5% to 30%.

[7] A method for producing a pellet, comprising: producing, by melt kneading with a twin screw extruder, a mixture comprising:

60 to 99 mass % of a polyphenylene ether resin (I); and

1 to 40 mass % of a block copolymer (II), which contains a polymer block P mainly comprising a vinyl aromatic compound, and a polymer block Q mainly comprising a conjugated diene compound of which a total amount of 1,2-vinyl bonding amount and 3,4-vinyl bonding amount is 5% or more and less than 50%, wherein:

in a flow direction of the mixture in the twin screw extruder, an oxygen concentration inside a material feed hopper located at an uppermost stream position is less than 3 volume %.

[8] The method for producing a pellet according to [7], wherein:

the twin screw extruder has a first kneading zone and a second kneading zone, and

has at least two vents on a downstream side of the first kneading zone, at least one among the vents being a gas releasing atmospheric open vent.

[9] The method for producing a pellet according to [8], wherein: a screw of the first kneading zone contains at least one orthogonal screw element, without containing pressure-up screw elements.

[10] The method for producing a pellet according to [8] or [9], wherein: a screw of the second kneading zone contains at least one pressure-up screw element.

[11] The method for producing a pellet according to any one of [8] to [10], wherein: the gas releasing atmospheric open vent portion is filled with an inactive gas.

[12] The method for producing a pellet according to any one of [8] to [11], wherein: in the flow direction of the mixture in the twin screw extruder, a barrel set temperature from a barrel on an uppermost stream side to a barrel on which the gas releasing atmospheric open vent is disposed is 300° C. or more.

[13] A resin modifier comprising the pellet according to any one of

[1] to [6].

[14] A thermoplastic resin composition comprising the resin modifier according to [13].

According to the pellet of this disclosure, it is possible to provide a pellet excellent in modification effect of heat-resistant creeping property improvement of thermoplastic resins such as polyethylene and the like, and excellent in appearance as well.

Moreover, according to the producing method according to this disclosure, it is possible to efficiently produce a pellet excellent in modification effect of heat-resistant creeping property improvement of thermoplastic resins such as polyethylene and the like, and excellent in appearance as well.

### BRIEF DESCRIPTION OF THE DRAWINGS

In the accompanying drawings:

FIG. 1 illustrates a schematic view (plan view) of the shape a test piece used for evaluating the modification performances of polyethylene.

### DETAILED DESCRIPTION

In the following, an embodiment for embodying this disclosure (hereinafter referred to as “the present embodiment” as well) is exemplified. This disclosure may be performed by varying within the scope of the subject thereof, without being limited to the following embodiment.

[Pellet]

The pellet of the present embodiment comprises 60 to 99 mass % of the polyphenylene ether resin (I) and 1 to 40 mass % of the block copolymer (II), and may further comprise a thermoplastic resin (III) other than the component (I) and the component (II) and an additive (IV) other than the component (I) to the component (III).

Further, in the present Specification, the polyphenylene ether resin (I) is referred to as component (I) in some cases. Moreover, the block copolymer (II) is referred to as component (II) in some cases.

Hereinafter, the components of the pellet of the present embodiment are described.

(Polyphenylene Ether Resin (I))

The polyphenylene ether resin (I) used in the present embodiment is exemplified as polyphenylene ethers, modified polyphenylene ethers, mixtures thereof, etc., without being limited thereto. The component (I) may be used alone or in a combination of two or more.

From the viewpoint of further improving the modification performances, the reduced viscosity of the polyphenylene ether resin (I) is preferably 0.25 dL/g or more, more preferably 0.28 dL/g or more; and preferably 0.55 dL/g or less, more preferably 0.53 dL/g or less, further more preferably 0.50 dL/g or less. The reduced viscosity may be controlled via the polymerization time and the catalyst amount.

Further, the reduced viscosity (η_{red}) may be determined with an Ubbelohde viscometer by measuring a chloroform solution adjusted to 0.5 g/dL at a temperature of 30° C., and dividing a specific viscosity ηₛₚ with a concentration c (g/dL) according to the following expression.

η_{red}=ηₛₚ/c

From the viewpoint of reducing the black spot foreign matters in the pellet, the degree of crosslinking of the polyphenylene ether resin (I) is preferably 0 to 0.3 mass %, more preferably 0 to 0.1 mass %.

Here, the degree of crosslinking may be measured according to the following method.

Weigh a mass A (mg) of the polyphenylene ether resin (I) with a mass of about 200 mg. Next, immerse this specimen in 20 mL of chloroform and apply ultrasonic vibration for more than 6 hours, and then separate soluble components and insoluble components via suction filtration. Subject the obtained residue (insoluble components) to vacuum drying at 100° C. for 2 hours, and then weigh the mass B (mg) of the insoluble components. Calculate the degree of crosslinking (unit: mass %) based on the obtained mass A and the mass B according to the following expression.

Degree of crosslinking (mass %)=100×(B/A)

—Polyphenylene Ether—

The polyphenylene ether is exemplified as homopolymers formed of a repeating unit represented by the following formula (1) and copolymers having a repeating unit represented by the following formula (1), without being limited thereto.

### [Formula (1)]

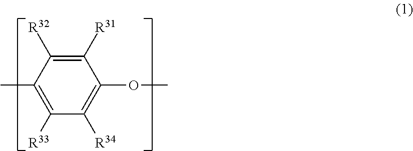

[In the formula, R³¹, R³², R³³ and R³⁴ are independent from each other, and are monovalent groups selected from the group consisting of hydrogen atom, halogen atom, C1 to C7 primary alkyl groups, C1 to C7 secondary alkyl groups, phenyl group, haloalkyl groups, aminoalkyl groups, hydrocarbon oxy groups, and halohydrocarbon oxy groups in which at least two carbon atoms are spaced by a halogen atom and an oxygen atom.]

Such polyphenylene ethers may be well-known ones without being limited thereto. The polyphenylene ether is specifically exemplified as homopolymers such as poly(2,6-dimethyl-1,4-phenylene ether), poly(2-methyl-6-ethyl-1,4-phenylene ether), poly(2-methyl-6-phenyl-1,4-phenylene ether), poly(2,6-dichloro-1,4-phenylene ether) and the like; copolymers such as copolymers of 2,6-dimethyl phenol and other phenols (e.g., 2,3,6-trimethyl phenol, 2-methyl-6-butyl phenol) and the like, among which poly(2,6-dimethyl-1,4-phenylene ether) and copolymers of 2,6-dimethyl phenol and 2,3,6-trimethyl phenol are preferable, and poly(2,6-dimethyl-1,4-phenylene ether) is more preferable.

The method for preparing polyphenylene ether may be conventionally known methods, without being limited thereto. The method for preparing polyphenylene ether is specifically exemplified as the method as disclosed in U.S. Pat. No. 3,306,874A, namely, producing 2,6-xylenol via oxidative polymerization, by using a complex of a cuprous salt and an amine as a catalyst; and the methods as disclosed in U.S. Pat. No. 3,306,875A, U.S. Pat. No. 3,257,357A, U.S. Pat. No. 3,257,358A, JPS5217880B2, JPS5051197A, JPS63152628A, etc.

—Modified Polyphenylene Ether—

The modified polyphenylene ether is exemplified as those obtained by grafting or adding styrene polymers or derivatives thereof to the aforementioned polyphenylene ether, without being limited thereto. The ratio of mass increase due to grafting or addition is preferably 0.01 mass % or more; and is preferably 10 mass % or less, more preferably 7 mass % or less, further more preferably 5 mass % or less, per 100 mass % of the modified polyphenylene ether, without being limited thereto.

The method for preparing the modified polyphenylene ether is exemplified as a method reacting the aforementioned polyphenylene ether and the styrene polymer or its derivative, with or without a radical precursor, in molten state, solution state or slurry state, at 80° C. to 350° C., without being limited thereto.

In the case that the polyphenylene ether resin (I) used in the present embodiment is a mixture of a polyphenylene ether and a modified polyphenylene ether, the mixing ratio the polyphenylene ether and the modified polyphenylene ether may be any ratio without being limited.

(Block Copolymer (II))

The block copolymer (II) used in the present embodiment is exemplified as unmodified block copolymers, modified block copolymers, and mixtures thereof, without being limited thereto. The component (II) may be used alone or in a combination of two or more.

The component (II) functions as a compatibilizing agent of the aforementioned component (I) and other resins such as polyethylene and the like.

The block copolymer (II) is a block copolymer comprising a polymer block P mainly comprising a vinyl aromatic compound, and a polymer block Q mainly comprising a conjugated diene compounds of which a total amount of 1,2-vinyl bonding amount and 3,4-vinyl bonding amount is 5% or more and less than 50%.

Hereinafter, the unmodified and modified block copolymers are described.

—Unmodified Block Copolymer—

### —Polymer Block P Mainly Comprising Vinyl Aromatic Compound—

The polymer block P mainly comprising a vinyl aromatic compound is exemplified as homopolymer blocks of vinyl aromatic compounds, and copolymer blocks of vinyl aromatic compounds and conjugated diene compounds, without being limited thereto.

Here, in the polymer block P, “mainly comprising a vinyl aromatic compound” refers to that the content of the constituent units derived from a vinyl aromatic compound in the polymer block P is more than 50 mass %, where the content is preferably 70 mass % or more, more preferably 80 mass % or more, and may be 100 mass % or less.

The vinyl aromatic compound is exemplified as styrene, a-methyl styrene, vinyl toluene, p-tert-butylstylene, diphenylethylene, without being limited thereto, among which styrene is preferable. The vinyl aromatic compound may be used alone or in a combination of two or more.

From the viewpoint of improving the modification performances, the number average molecular weight (Mn) of the polymer block P is preferably 15,000 or more, more preferably 20,000 or more, further more preferably 25,000 or more, and preferably 100,000 or less.

Here, in the present Specification, the number average molecular weight (Mn) and the weight average molecular weight (Mw) may be determined via a conventionally known method, by using GPC (mobile phase: chloroform, standard substance: polystyrene).

—Polymer Block Q Main Comprising Conjugated Diene Compound—

The polymer block Q main comprising a conjugated diene compound is exemplified as homopolymer blocks of conjugated diene compounds, and copolymer blocks of conjugated diene compounds and vinyl aromatic compounds, without being limited thereto.

Here, in the polymer block Q, “mainly comprising a conjugated diene compound” refers to that the content of the constituent units derived from a conjugated diene compound in the polymer block Q is more than 50 mass %, and from the viewpoint of improving the fluidity of the pellet, the content is preferably 70 mass % or more, more preferably 80 mass % or more, and may be 100 mass % or less.

The conjugated diene compound is exemplified as butadiene, isoprene, 1,3-pentadiene, 2,3-dimethyl-1,3-butadiene, and combinations thereof, among which butadiene, isoprene and combinations thereof are preferable, and butadiene is more preferable. The conjugated diene compound may be used alone or in a combination of two or more.

Moreover, the polymer block Q may be hydrogenated partially or entirely.

From the viewpoint of easiness to provide creep resistance to the thermoplastic resin such as polyethylene and the like, the total amount of 1,2-vinyl bonding amount and 3,4-vinyl bonding amount in the aforementioned conjugated diene compound is less than 50%, preferably 40% or less, more preferably 30% or less, and is 5% or more.

Here, the “total amount of 1,2-vinyl bonding amount and 3,4-vinyl bonding amount” refers to a ratio of the total amount of 1,2-vinyl bonding amount and 3,4-vinyl bonding amount to the total amount of 1,2-vinyl bonding amount, 3,4-vinyl bonding amount and 1,4-conjugated bonding amount. The vinyl bonding amount may be calculated according to the method as described in Analytical Chemistry, Volume 21, No. 8, August 1949, by measuring with an infrared spectrophotometer.

From the viewpoint of improving the modification performances, the number average molecular weight (Mn) of the polymer block Q is preferably 20,000 or more, more preferably 25,000 or more, further more preferably 30,000 or more, and preferably 100,000 or less.

The method for synthesizing the block copolymer comprising the polymer block P and the polymer block Q is exemplified as well-known methods such as anionic polymerization and the like, without being limited thereto.

The block structure of the block copolymer comprising the polymer block P and the polymer block Q is exemplified as the structures such as P-Q, P-Q-P, Q-P-Q-P, (P-Q-)₄M, P-Q-P-Q-P and the like, where “P” represents the polymer block P, and “Q” represents the polymer block Q, without being limited thereto. Here, the M in (P-Q-)₄M is a reaction residual group of a multifunctional coupling agent such as silicon tetrachloride (M=Si), tin tetrachloride (M=Sn) and the like, or a residual group of an initiator of multifunctional organic lithium compounds, etc.

Among the aforementioned coupling agents, as bifunctional coupling agents, exemplified are well-known ones including: epoxy compounds; silicon halide compounds such as dichlorodimethylsilane, phenylmethyldichlorosilane and the like; alkoxy silicone compounds such as dimethyldimethoxysilane, dimethyldiethoxysilane and the like; tin compounds such as dimethyltin dichloride and the like; ester compounds such as methyl benzoate, ethyl benzoate, phenyl benzoate, phthalic esters and the like; vinyl allenes such as divinylbenzene and the like, etc., without being limited thereto.

As trifunctional coupling agents, exemplified are well-known ones including: tin compounds such as methyltin trichloride, tributyltin chloride and the like; silane compounds such as trimethoxysilane, triethoxysilane and the like; silicon halide compounds such as methyl silicon trichloride, trimethyl silicon chloride and the like, etc., without being limited thereto.

As tetrafunctional coupling agents, exemplified are well-known ones including: tin halide compounds such as tin tetrachloride; allyl tin compounds such as tetraallyl tin, tetra(2-octenyl)tin and the like; tin compounds such as tetraphenyltin, tetrabenzyltin and the like; silicon halide compounds such as silicon tetrachloride, silicon tetrabromide and the like; alkoxy silicon compounds such as silicon tetraphenoxide, silicon tetraethoxide and the like, etc., without being limited thereto.

The molecular structure of the block copolymer comprising the polymer block P and the polymer block Q is exemplified as straight chain, branched, radial, or combinations thereof, without being limited thereto.

The distribution of the unit derived from the vinyl aromatic compound in the molecular chain in the polymer block P contained in the aforementioned block copolymer and the unit derived from the conjugated diene compound in the molecular chain in the polymer block Q contained in the aforementioned block copolymer is exemplified as random, tapered (the monomer portion increasing or decreasing along the molecular chain), partially block-like, or combinations thereof, without being limited thereto.

In the case where the block copolymer comprises a plurality of the polymer blocks P and/or the polymer blocks Q, the plurality of the polymer blocks P or the plurality of the polymer blocks Q may be respectively of the same structure or different structures.

From the viewpoint of improving the fluidity, the impact resistance and the appearance of the block copolymer (II), and reducing weldment occurrence, the content of the unit derived from the aforementioned vinyl aromatic compound with respect to the entire block copolymer containing the polymer block P and the polymer block Q is preferably 20 mass % or more, more preferably 30 mass % or more, and preferably 95 mass % or less, more preferably 80 mass % or less.

Here, the content of the unit derived from the vinyl aromatic compound may be measured by using a UV spectrophotometer.

The number average molecular weight (Mn) of the block copolymer is preferably 5,000 or more, more preferably 10,000 or more, further more preferably 30,000 or more, and preferably 1,000,000 or less, more preferably 800,000 or less, further more preferably 500,000 or less.

Here, in the case of using a hydrogenated block copolymer, the aforementioned number average molecular weight refers to the number average molecular weight before hydrogenation.

The molecular weight distribution (Mw/Mn) of the block copolymer is preferably 10 or less, more preferably 8 or less, further more preferably 5 or less.

Here, in the case of using a hydrogenated block copolymer, the aforementioned molecular weight distribution refers to the molecular weight distribution before hydrogenation.

The method for hydrogenating the aforementioned block copolymer is exemplified as a method for hydrogenation at a reaction temperature of 0 to 200° C. and a hydrogen pressure of 0.1 to 15 MPa, by using: (1) a supported heterogeneous hydrogenation catalyst, obtained by carrying a metal such as Ni, Pt, Pd, Ru and the like on carbon, silica, alumina, diatomaceous earth, etc., (2) a so-called Ziegler-type hydrogenation catalyst using organic acid salts of Ni, Co, Fe, Cr, etc. or a transition metal salt such as acetylacetonates and the like, and using a reductant such as organic aluminum and the like, and (3) a homogeneous hydrogenation catalyst such as so-called organic metal complexes of organic metal compounds of Ti, Ru, Rh, Zr, etc. and the like, without being limited thereto.

The hydrogenation ratio of the conjugated diene compound portion in the polymer block Q in the block copolymer (II) is not specifically limited.

Here, the hydrogenation ratio may be measured by using a nuclear magnetic resonance (NMR) apparatus.

The method for producing the block copolymer (II) is exemplified as well-known methods, such as the methods as disclosed in JPS3619286B1, JPS4317979B1, JPS4632415B1, JPS4936975B1, JPS482423B1, JPS484106B1, JPS5628925B1, JPS59166518A, JPS60186577A, without being limited thereto. According to the aforementioned methods, it is possible to synthesize a block copolymer with the aforementioned structure.

In the case where the block copolymer (II) is hydrogenated, the method for producing the same may be well-known producing methods, without being limited thereto. Specific examples for the well-known producing methods are the methods as disclosed in JPS4711486A, JPS4966743A, JPS5075651A, JPS54126255A, JPS5610542A, JPS5662847A, JPS56100840A, JPH02300218A, GB1130770A, U.S. Pat. No. 3,281,383A, U.S. Pat. No. 3,639,517A, GB1020720A, U.S. Pat. No. 3,333,024A, and U.S. Pat. No. 4,501,857A.

—Modified Block Copolymer—

The modified block copolymer is obtained by grafting or adding an α,β-unsaturated carboxylic acid or a derivative thereof (e.g., acid anhydride, ester, etc.) to the aforementioned unmodified block copolymer.

The ratio of mass increase due to grafting or addition per 100 mass % of the modified block copolymer is preferably 0.01 mass % or more, and preferably 10 mass % or less, more preferably 7 mass % or less, further more preferably 5 mass % or less, without being limited thereto.

The method for producing the modified block copolymer is exemplified as a method reacting an unmodified block copolymer and an α,β-unsaturated carboxylic acid or a derivative thereof, with or without a radical precursor, in molten state, solution state or slurry state, at 80° C. to 350° C., without being limited thereto.

(Thermoplastic Resin (III) Other than Component (I) and Component (II))

The thermoplastic resin (III) Other than the component (I) and the component (II) used optionally in the present embodiment is exemplified as polystyrene, syndiotactic polystyrene and high impact polystyrene, without being limited thereto.

(Additive (IV) Other than Component (I) to Component (III))

The additive (IV) other than the component (I) to the component (III) optionally used in the present embodiment is exemplified as block copolymers of vinyl aromatic compound-conjugated diene compound; olefin elastomers; fluorine-based polymers; plasticizers such as low molecular weight polyethylene, epoxidized soybean oil, polyethylene glycol, fatty acid esters and the like; flame retardants such as alkali metal phosphinic acid compound, melamine pyrophosphate, melamine polyphosphate, phosphate ester compounds, ammonium polyphosphate, magnesium hydroxide, aromatic halogen based flame retardants, silicone based flame retardants, zinc borate and the like; flame retardant promoters such as antimony trioxide and the like;

inorganic or organic fillers; inorganic or organic reinforcement agents such as carbon black, titanium oxide, calcium carbonate, mica, kaolin, glass fiber, glass flake, conductive carbon black, talc, wollastonite and the like; antioxidants; metal deactivators; heat stabilizers; weather (light) resistance improvers; nucleating agents for polyolefin; slip agents; colorants; release agents, etc., without being limited thereto.

Hereinafter, the ratio of the components in the pellet of the present embodiment is described.

From the viewpoint of improving the modification performances, the content of the component (I) in the pellet of the present embodiment to the entire pellet is 60 mass % or more, preferably 70 mass % or more, more preferably 80 mass % or more, and from the viewpoint of excellent appearance, is 99 mass % or less, preferably 98 mass % or less, more preferably 97 mass % or less.

From the viewpoint of improving the modification performances, the content of the component (II) in the pellet of the present embodiment to the entire pellet is 1 mass % or more, preferably 2 mass % or more, more preferably 3 mass % or more, and from the viewpoint of suppressing peeling from the pellet, is 40 mass % or less, preferably 30 mass % or less, more preferably 20 mass % or less.

Each content of the component (III) and the component (IV) in the pellet of the present embodiment may be 0 to 400 parts by mass with respect to the total amount of the pellet (100 parts by mass), without being limited thereto as long as not deteriorating the effects of this disclosure.

—Number of Black Spot Foreign Matters—

No black spot foreign matters with a longitudinal diameter of more than 0.7 mm are observed on front and back surfaces of four flat plates obtained by molding the pellet of the present embodiment into a size of 90.0mm×50.0mm×2.0mm (8 surfaces in total, with a total area of 36000 mm²).

The number of black spot foreign matters with a longitudinal diameter of more than 0.5 mm and 0.7 mm or less measured on the front and back surfaces of the aforementioned four flat plates is preferably 5 or less, more preferably 3 or less.

The number of black spot foreign matters with a longitudinal diameter of more than 0.3 mm and 0.5 mm or less measured on the front and back surfaces of the aforementioned four flat plates is preferably 10 or less, more preferably 6 or less.

Here, the black spot foreign matters refer to black spot foreign matters generated during procedure of crosslinking, in the case that the polyphenylene ether resin is exposed to long time high temperature, or exposed to oxygen at high temperature.

The number of black spot foreign matters may be measured via the method described in “(1) Longitudinal diameter and number of black spot foreign matters” of the example mentioned below. Moreover, the “longitudinal diameter” refers to a maximum diameter in a plan view of the black spot foreign matters.

The number of the foreign matters may be controlled via the following producing method.

The pellet of the present embodiment may be produced via the method for producing a pellet mentioned below.

The pellet of the present embodiment contains polyphenylene ether at a high concentration, and thus is capable of providing creep resistance, heat resistance, etc., by mixing with resins such as polyethylene and the like.

The pellet of the present embodiment may be used preferably for modifying (e.g., providing creep resistance, heat resistance, etc.) thermoplastic resins (in particular, polyethylene), and the modified resin may be used in vehicle members, interior and exterior members of electronic equipments, and other members, etc.

The vehicle members are exemplified as exterior members such as bumper, fender, door panel, various moldings, emblem, engine hood, wheel cap, roof, spoiler, various aero parts and the like; modification of rubbers as vehicle tire material; interior members such as instrument panel, console box, trim and the like; battery case members for secondary battery installed on vehicles, electric vehicles, hybrid electric vehicles and the like; lithium ion secondary battery members, etc, without being limited thereto.

The interior and exterior members of electronic equipments are exemplified as members used in various computers and peripheral equipments thereof, other office automation apparatus, television, video recorder, cabinets for various disc players, chassis, refrigerator, air conditioner, LCD projector and the like, without being limited thereto.

The other members are exemplified as wires and cables obtained by applying a coating on a metal conductor or optical fiber, fuel case for solid methanol battery, water pipe for fuel cell, water cooling tank, boiler exterior case, ink peripheral members and parts for inkjet printer, furniture (chairs, etc.), chassis, water piping, joint, etc.

[Method for Producing a Pellet]

The method for producing a pellet of the present embodiment is exemplified as a producing method by melt kneading with a twin screw extruder a mixture comprising: 60 to 99 mass % of a polyphenylene ether resin (I), and 1 to 40 mass % of a block copolymer (II) containing a polymer block P mainly comprising vinyl aromatic compounds, and a polymer block Q mainly comprising conjugated diene compounds of which a total amount of 1,2-vinyl bonding amount and 3,4-vinyl bonding amount is 5% or more and less than 50%. In the aforementioned producing method, in the flow direction of the mixture of the aforementioned twin screw extruder, the oxygen concentration inside the material feed hopper located at the uppermost stream position is preferably less than 3 volume %.

The mixture in the producing method of the present embodiment may be produced by mixing the component (I) and the component (II), and, if necessary, the component (III) and the component (IV).

The device used for melt kneading is exemplified as single screw or multi screw kneading extruder, roll, Banbury mixer, etc. Among the above, twin screw extruder is preferably, and twin screw extruder with pressure reducing device is more preferable. Twin screw extruder is specifically exemplified as ZSK series made by Coperion Inc., TEM series made by Toshiba Machine Co., Ltd., TEX series made by the Japan Steel Works, Ltd.

The method for melt kneading is exemplified as a method melt kneading all the components simultaneously, a method melt kneading a mixture mixed preliminarily, etc.

In order to reduce black spot foreign matters after molding the pellet, regarding the screw configuration and the position of the vent when melt kneading the mixture with a twin screw extruder, it is preferable to apply at least one of the following (a) to (h).

(a) Set the oxygen concentration inside a powder material feeding and collecting hopper on an uppermost stream side of the twin screw extruder to less than 3 volume %.
(b) Include a single flight screw zone of which L/D (screw axial length/screw diameter)=4.5 to 20.
(c) Include a double flight screw zone of which L/D=4 to 20 on a downstream side of the aforementioned single flight screw zone.
(d) Include a first kneading zone of which L/D=3 to 8, containing two orthogonal screw elements, without containing pressure-up screw elements, on the downstream side of the aforementioned double flight screw zone (e.g., in the case where a plurality of double flight screw zones are included, a double flight screw zone on the uppermost stream side in the flow direction of the mixture).
(e) Include an atmospheric gas vent or vacuum vent on the downstream side of the aforementioned first kneading zone.
(f) Include a second kneading zone of which L/D=3 to 12, including at least one pressure-up screw element on the downstream side of the aforementioned atmospheric gas vent or vacuum vent.
(g) Fill the aforementioned atmospheric gas vent with an inactive gas.
(h) Include a vacuum vent on the downstream side of the aforementioned second kneading zone.

Here, the solid transport zone, the first kneading zone, the second kneading zone, the single flight screw zone and the double flight screw zone may be defined in terms of barrel unit.

(i) In the case where the aforementioned first kneading zone is on the downstream side (e.g., after barrel 9 in the case of 13 barrels), the first kneading zone and the second kneading zone are spaced by two or more barrels.

From the viewpoint of reducing black spot foreign matters in the obtained pellet, it is preferable to use a vent disposed on the downstream side of the first kneading zone as the atmospheric gas vent (gas releasing atmospheric open vent), and provide an inactive gas to this portion.

The barrel temperature setting of the twin screw extruder may be selected from, e.g., a temperature of 250° C. to 350° C., but from the viewpoint of ensuring stable productivity, it is preferably to set the set temperature between the uppermost stream side of the twin screw extruder and the vent set on the downstream side of the first kneading zone to 300° C. or more.

Moreover, in the case of disposing a gas releasing atmospheric open vent, from the viewpoint of ensuring stable productivity, in the flow direction of the mixture in the twin screw extruder, the barrel set temperature from the barrel on the uppermost stream side to the barrel on which the aforementioned gas releasing atmospheric open vent is disposed is preferably set to 300 ° C. or more.

The aforementioned twin screw extruder preferably has a first kneading zone and a second kneading zone, and from the viewpoint of improving the productivity, is preferably a twin screw extruder having at least two vents in total on the downstream side than the aforementioned first kneading zone, where at least one of the aforementioned vents is a gas releasing atmospheric open vent, more preferably a twin screw extruder having at least one vent respectively, and at least two vents in total, between the aforementioned first kneading zone and the aforementioned second kneading zone, and on the downstream side of the aforementioned second kneading zone, where at least one of the aforementioned vents is a gas releasing atmospheric open vent. Here, from the viewpoint of reducing black spot foreign matters of the pellet, the aforementioned gas releasing atmospheric open vent is preferably filled with an inactive gas such as nitrogen and the like.

Moreover, from the viewpoint of improving the productivity and reducing black spot foreign matters, the aforementioned twin screw extruder is preferably a twin screw extruder of which the screw of the aforementioned first kneading zone contains at least one orthogonal screw element, without containing pressure-up screw elements.

Moreover, from the viewpoint of improving the kneading efficiency, the aforementioned twin screw extruder is preferably a twin screw extruder of which the screw of the aforementioned second kneading zone contains at least one pressure-up screw element.

Hereinafter, described is a preferably embodiment in the case of using a single screw extruder, or a multi screw extruder such as twin screw extruder and the like.

The type and standard of the extruder may be well-known ones without being limited.

The L/D (effective barrel length/barrel internal diameter) of the extruder is preferably 30 or more, more preferably 40 or more, and preferably 75 or less, more preferably 60 or less.

The screw rotation number is ordinarily 100 to 1200 rpm, without being limited thereto.

In the case of adding a liquid material, the liquid material may be added by feeding the same directly into the cylinder system by using a tubing pump, etc. in the extruder cylinder portion. The tubing pump is exemplified as gear pump, flange pump, etc., without being limited thereto, among which gear pump is preferable. In this case, from the viewpoint of reducing the load to the tubing pump and improving the operability of the material, it is preferably to lower the viscosity of the liquid material, by heating with a heater, etc. the tank for storing the liquid material, and the portion functioning as a flow path of the liquid material, such as the piping between the tank and the tubing pump, the piping between the pump and the extruder cylinder, etc.

The pellet of the present embodiment is optimum for use as a resin modifier. The resin modifier of the present embodiment comprises the pellet of the present embodiment (preferably, the resin modifier of the present embodiment is formed of the pellet), and may further contain other components as well.

The resin modifier of the present embodiment is capable of modifying properties of a resin, by providing creep resistance, heat resistance, etc. to a thermoplastic resin such as polyethylene and the like.

The thermoplastic resin composition of the present embodiment contains the resin modifier of the present embodiment. Further, the thermoplastic resin composition may contain: thermoplastic resins such as polyolefins such as polyethylene, polypropylene and the like, polystyrene, and others; and other components such as block copolymers of vinyl aromatic compound-conjugated diene compound, olefin elastomers, antioxidants, metal deactivators, heat stabilizers, flame retardants (ammonium polyphosphate compounds, melamine polyphosphate compounds, magnesium hydroxide, aromatic halogen based flame retardants, silicone based flame retardants, zinc borate, etc.), fluorine-based polymers, plasticizers (low molecular weight polyethylene, epoxidized soybean oil, polyethylene glycol, fatty acid esters, etc.), flame retardant promoters such as antimony trioxide and the like, weather (light) resistance improvers, nucleating agents for polyolefin, slip agents, inorganic or organic fillers or reinforcement agents (GF, GF long fiber, CF, CF long fiber, polyacrylonitrile fiber, carbon black, titanium oxide, calcium carbonate, conductive metal fiber, conductive carbon black, etc.), colorants, release agents, etc.

The content of the resin modifier with respect to the entire amount (100 mass %) of the thermoplastic resin composition of the present embodiment is preferably 0.5 to 50 mass %.

The thermoplastic resin composition of the present embodiment may be produced by, e.g., mixing a thermoplastic resin and the resin modifier of the present embodiment, and then melt kneading the same.

According to the thermoplastic resin composition of the present embodiment, since a resin modifier comprising a polyphenylene ether resin at a high concentration is used, as compared to the case of producing by using polyphenylene ether resin powder, dust explosion from the atmospheric open vent of the polyphenylene ether resin is unlikely to occur, and it becomes easier to uniformly disperse the polyphenylene ether resin and provide creep resistance.

The thermoplastic resin composition of the present embodiment is excellent in creep resistance, and thus may be used in vehicle members, interior and exterior members of electronic equipments, and other members, etc. The aforementioned vehicle members, the aforementioned interior and exterior members of electronic equipments, and the aforementioned other members are exemplified as those mentioned above.

### EXAMPLES

Hereinafter, the embodiment for embodying this disclosure are described by referring to examples, while this disclosure is not limited to these examples.

The raw materials used in the pellets of the examples and comparative examples are as follows.

### —Polyphenylene Ether Resin (I)—

(I-i) A polyphenylene ether (trade name: “XYRON S201A”, made by Asahi

Kasei Corporation) with a reduced viscosity (a chloroform solution, ηₛₚ/c: 0.50 g/dL) of 0.33 dL/g, which is obtained via oxidative polymerization of 2,6-xylenol.

(I-ii) A polyphenylene ether (trade name: “XYRON 5202A”, made by Asahi Kasei Corporation) with a reduced viscosity (a chloroform solution, ηₛₚ/c:

0.50 g/dL) of 0.42 dL/g, which is obtained via oxidative polymerization of 2,6-xylenol.

Here, the reduced viscosity was measured at a temperature of 30° C., by using a chloroform solution, ηₛₚ/c: 0.5 g/dL.

—Block Copolymer (II)—

The block copolymer was synthesized by using polystyrene (homopolymer) as the polymer block P, and polybutadiene (homopolymer) as the polymer block Q. Modification of polymer was not performed. The physical properties of the obtained unmodified block copolymers are as follows.

(II-i) P-Q-P-Q type (hydrogenated type)

Number average molecular weight (Mn) of polystyrene block before hydrogenation: 46,800,

Number average molecular weight (Mn) of polybutadiene block before hydrogenation: 38,000,

Content of polystyrene in block copolymer before hydrogenation: 60 mass %

Number average molecular weight (Mn) of block copolymer before hydrogenation: 84,800,

Molecular weight distribution (Mw/Mn) of block copolymer: 1.20,

Entire vinyl bonding amount (1,2-vinyl bonding amount) in polybutadiene block: 36%,

Hydrogenation ratio with respect to the polybutadiene portion for forming the polybutadiene block: 99.9%

(II-ii) P-Q-P-Q type (unhydrogenated type)

Number average molecular weight (Mn) of polystyrene block: 42,000,

Number average molecular weight (Mn) of polybutadiene block: 58,000,

Content of polystyrene in block copolymer: 42 mass %,

Number average molecular weight (Mn) of block copolymer: 100,000,

Molecular weight distribution (Mw/Mn) of block copolymer: 1.18,

Entire vinyl bonding amount (1,2-vinyl bonding amount) in polybutadiene block: 8%,

(II-x-i) Q-P-Q-P type (hydrogenated type)

Number average molecular weight (Mn) of polystyrene block: 41,800,

Number average molecular weight (Mn) of polybutadiene block: 53,200,

Content of polystyrene in block copolymer before hydrogenation: 44 mass %,

Number average molecular weight (Mn) of block copolymer before hydrogenation: 95,000,

Molecular weight distribution (Mw/Mn) of block copolymer before hydrogenation: 1.06,

Entire vinyl bonding amount (1,2-vinyl bonding amount) in polybutadiene block before hydrogenation: 75%,

Hydrogenation ratio with respect to the polybutadiene portion for forming the polybutadiene block: 99.9%

Here, the content of polystyrene was measured by using a UV spectrophotometer. The number average molecular weight (Mn) was determined via a conventionally known method, by using GPC (mobile phase: chloroform, standard substance: polystyrene). The molecular weight distribution (Mw/Mn) was determined by dividing a weight average molecular weight (Mw) determined via a conventionally known method by using GPC (mobile phase: chloroform, standard substance: polystyrene), with the number average molecular weight (Mn). The entire vinyl bonding amount was calculated according to the method as described in Analytical Chemistry, Volume 21, No.8, August 1949, by measuring with an infrared spectrophotometer. The hydrogenation ratio was measured by using a nuclear magnetic resonance (NMR) apparatus.

### (II-x-ii)

hydrogenated aromatic modified terpene resin (trade name: “Clearon M115”, made by Yasuhara Chemical Co., Ltd.)

The methods for measuring the physical properties of the examples and comparative examples are as follows.

(1) Longitudinal Diameter and Number of Black Spot Foreign Matters

The obtained pellet was provided to a small size injection molding machine (trade name: IS-100GN, made by Toshiba Machine Co., Ltd.), of which the cylinder temperature was set to 320° C.; and was molded at the conditions of a mold temperature of 90° C., and an injection pressure of 60 MPa, to obtain a flat plate specimen of 90.0 mm×50.0 mm×2.0 mm. Regarding these four flat plates, the longitudinal diameter and number of black spot foreign matters were measured, by observing the eight front and back surfaces in total of each specimen, and by using a scale.

Moreover, the appearance of the specimen was evaluated according to the following standard.

Excellent: no black spot foreign matters with a longitudinal diameter of more than 0.7 mm, 5 or less black spot foreign matters with a longitudinal diameter of more than 0.5 mm and 0.7 mm or less, and 10 or less black spot foreign matters with a longitudinal diameter of more than 0.3 mm and 0.5 mm or less.

Good: no black spot foreign matters with a longitudinal diameter of more than 0.7 mm, 5 or less black spot foreign matters with a longitudinal diameter of more than 0.5 mm and 0.7 mm or less, but more than 10 black spot foreign matters with a longitudinal diameter of more than 0.3 mm and 0.5 mm or less.

Poor: black spot foreign matters with a longitudinal diameter of more than 0.7 mm existing.

(2) Modification Performances of Polyethylene

Producing method (A): the obtained pellet and a homopolyethylene, of which the MFR measured at a load condition of 2.16 kg at 190° C. was 20 g/10 minutes, were subjected to melted kneading, to obtain a modified polyethylene (modified PE), of which the content of polyphenylene ether resin was 10 mass %.

Producing method (B): a polyphenylene ether resin powder and a block copolymer were added respectively without using the pellet of the present embodiment, to obtain a modified polyethylene (modified PE) with a composition totally the same as the producing method (A).

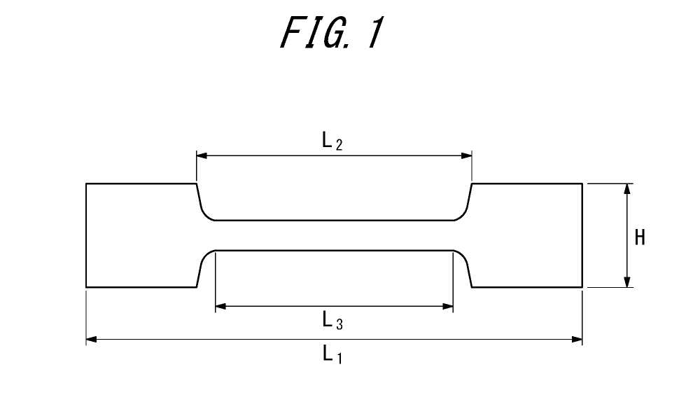

The pellets of modified polyethylene obtained via the producing methods (A) and (B) were provided to a Ti-50G2 molding machine made by Toyo Machinery & Metal Co., Ltd., of which the cylinder temperature was set to 245° C., and was molded at the conditions of a mold temperature of 60° C. and an injection pressure of 65 MPa, to obtain a test piece for creep measurement. Here, a dumbbell-shaped molded product (thickness: 1 mm) with the shape as illustrated in FIG. 1 was used as the test piece for creep measurement. The test piece had a width L₁ of 65 mm, a width L₂ of 40 mm, a width L₃ of 22 mm, and a height H of 10 mm.

The obtained test piece for creep measurement was subjected to creep measurement (heat-resistant creeping property test) at the conditions of a distance between chucks of 40 mm, a testing load corresponding to a stress of 4.0 MPa, a testing temperature of 50° C., and a testing time of 100 hours, by using a creep testing machine (“145-B-PC type”, made by Yasuda Seiki Seisakusho, Ltd.). The heat-resistant creeping property (creeping property) was evaluated based on a strain [%] determined according to the following expression. A lower value of this strain shows an excellent creeping property.

Strain [%]=(displacement of test piece after 165 hours)/(distance between chucks)×100

(3) Production Stability

When producing the pellet, the discharge amount per unit time (kg/h) discharged from the extruder was recorded as an indicator for the production efficiency. A larger value shows an excellent production efficiency.

Moreover, during production of the pellet, presence/absence of melted resin composition blown out from the atmospheric open vent (presence/absence of vent-up) was certified. In the case without vent-up, the safety during production and the production efficiency was evaluated as excellent.

Hereinafter, each example and each comparative example are described in details.

### Examples 1 to 19, Comparative Examples 1 to 14

As a melt kneader used for production of the pellets of each example and each comparative example, a twin screw extruder (TEM-58SS, made by Toshiba Machine Co., Ltd.) was used. The L/D of the extruder was 54.

The twin screw extruder was one having 13 barrels, and the screw configuration was as shown in Table 1. Here, the meaning of the symbols showing the screw configuration in Table 1 is as follows.

Single flight: pitch L/D=1.3

Double flight: pitch L/D=1.3

R1: kneading disc right (L/D=1.0)

R2: kneading disc right (L/D=0.5)

L (pressure-up type): kneading disc left (L/D=0.5)

N (orthogonal type): kneading disc neutral (L/D=1.0)

In each example and each comparative example, pellets were obtained at the compositions and production conditions as shown in Table 2 and Table 3. The obtained pellets were subjected to measurement of physical properties according to the aforementioned methods, and the results were as shown in Table 2 and Table 3.

TABLE 1

| | Screw configuration 1 | | Screw configuration 2 | | Screw configuration 3 | |
|---|---|---|---|---|---|---|
| Barrel 1 | Material feed | Single flight | Material feed | Single flight | Material feed | Single flight |
| | Solid transport | | Solid transport | | Solid transport | |
| | zone | | zone | | zone | |
| Barrel 2 | | | | | | |
| Barrel 3 | | Double flight | | Double flight | | Double flight |
| Barrel 4 | | | | | | |
| Barrel 5 | | | | | | |
| Barrel 6 | | | | | | |
| Barrel 7 | First kneading | R1, R2, N, | First kneading | R1, R2, R1, | First kneading | R1, R2, N, |
| | zone | R2, N, R2 | zone | R2, R1, R2 | zone | L, R2 |
| Barrel 8 | Atmospheric | Double flight | Atmospheric | Double flight | Atmospheric | Double flight |
| | open vent | | open vent | | open vent | |
| Barrel 9 | | | | | | |
| Barrel 10 | Second kneading | R2, R2, N, | Second | R2, R2, N, | Second kneading | R2, R2, N, |
| | zone | L, R2 | kneading zone | L, R2 | zone | L, R2 |
| Barrel 11 | Vacuum vent | Double flight | Vacuum vent | Double flight | Vacuum vent | Double flight |
| Barrel 12 | | | | | | |
| Barrel 13 | | | | | | |
| | Screw configuration 4 | | Screw configuration 5 | | Screw configuration 6 | |
| Barrel 1 | Material feed | Single flight | Material feed | Single flight | Material feed | Single flight |
| | Solid transport | | Solid transport | | Solid transport | |
| | zone | | zone | | zone | |
| Barrel 2 | | | | | | |
| Barrel 3 | | Double flight | | Double flight | | Double flight |
| Barrel 4 | | | First kneading | R1, R2, N, | | |
| | | | zone | R2, N, R2 | | |
| Barrel 5 | | | Atmospheric | Double flight | | |
| | | | open vent | | | |
| Barrel 6 | | | | | | |
| Barrel 7 | First kneading | R1, R2, N, | | | | |
| | zone | R2, N, R2 | | | | |
| Barrel 8 | | Double flight | | | | |
| Barrel 9 | | | | | First kneading | R1, R2, N, |
| | | | | | zone | R2, N, R2 |
| Barrel 10 | Second kneading | R2, R2, N, | Second kneading | R1, N, L | Atmospheric | Double flight |
| | zone | L, R2 | zone | | open vent | |
| Barrel 11 | Vacuum vent | Double flight | Vacuum vent | Double flight | Second kneading | R1, N, L |
| | | | | | zone | |
| Barrel 12 | | | | | Vacuum vent | Double flight |
| Barrel 13 | | | | | | |

TABLE 2

| | | | | Example 1 | Example 2 | Example 3 | Example 4 | Example 5 | Example 6 |
|---|---|---|---|---|---|---|---|---|---|
| Pellet | Component (I) | Component (I-i) | Mass % | 60 | 80 | 90 | 90 | 95 | — |
| | | Component (I-ii) | Mass % | — | — | — | — | — | 60 |
| | Component (II) | Component (II-i) | Mass % | — | — | 10 | — | — | — |
| | | Component (II-ii) | Mass % | 40 | 20 | — | 10 | 5 | 40 |
| | | Component (II-x-ii) | Mass % | — | — | — | — | — | — |
| | | Component (II-x-ii) | Mass % | — | — | — | — | — | — |
| Method | Screw configuration | | | 1 | 1 | 1 | 1 | 1 | 1 |
| for | Barrel | Barrel 1 | ° C. | 320 | 320 | 320 | 320 | 320 | 320 |
| producing | temprature | Barrel 2 | ° C. | 320 | 320 | 320 | 320 | 320 | 320 |
| pellet | | Barrel 3 | ° C. | 320 | 320 | 320 | 320 | 320 | 320 |
| | | Barrel 4 | ° C. | 320 | 320 | 320 | 320 | 320 | 320 |
| | | Barrel 5 | ° C. | 320 | 320 | 320 | 320 | 320 | 320 |
| | | Barrel 6 | ° C. | 320 | 320 | 320 | 320 | 320 | 320 |
| | | Barrel 7 | ° C. | 320 | 320 | 320 | 320 | 320 | 320 |
| | | Barrel 8 | ° C. | 320 | 320 | 320 | 320 | 320 | 320 |
| | | Barrel 9 | ° C. | 270 | 270 | 270 | 270 | 270 | 270 |
| | | Barrel 10 | ° C. | 270 | 270 | 270 | 270 | 270 | 270 |
| | | Barrel 11 | ° C. | 270 | 270 | 270 | 270 | 270 | 270 |
| | | Barrel 12 | ° C. | 270 | 270 | 270 | 270 | 270 | 270 |
| | | Barrel 13 | ° C. | 270 | 270 | 270 | 270 | 270 | 270 |
| | Nitrogen flow to atmospheric open vent | | Presence/ | Presence | Presence | Presence | Presence | Presence | Presence |
| | | | Absence | | | | | | |
| | Screw rotation number | | rpm | 230 | 230 | 230 | 230 | 230 | 230 |
| | Oxygen concentration in the collecting hopper on the | | Volume % | 0.5 | 0.5 | 0.5 | 0.5 | 0.5 | 0.5 |
| | uppermost stream side | | | | | | | | |
| Evaluation | (1) | Longitudinal diameter more than | Number | 0 | 0 | 0 | 0 | 0 | 0 |
| | Longitudinal | 0.7 mm | | | | | | | |
| | diameter and | Longitudinal diameter more than | Number | 0 | 0 | 0 | 1 | 1 | 0 |
| | number of black | 0.5 mm and 0.7 mm or less | | | | | | | |
| | spot foreign matters | Longitudinal diameter more than | Number | 1 | 3 | 4 | 4 | 5 | 1 |
| | | 0.3 mm and 0.5 mm or less | | | | | | | |
| | | Evaluation of appearance | | Excellent | Excellent | Excellent | Excellent | Excellent | Excellent |
| | (2) | Creeping performances of | Strain % | 25 | 22 | 19 | 17 | 14 | 23 |
| | Modification | modified PE: production | | | | | | | |
| | performances of PE | method (A) | | | | | | | |
| | | Creeping performances of | Strain % | 33 | 29 | 25 | 23 | 19 | 29 |
| | | modified PE: production | | | | | | | |
| | | method (B) | | | | | | | |
| | (3) | Vent-up from the atmospheric | Presence/ | Absence | Absence | Absence | Absence | Absence | Absence |
| | Production stability | open vent | Absence | | | | | | |
| | | Discharge amount | kg/h | 250 | 250 | 250 | 250 | 250 | 250 |

| | | | | Example 7 | Example 8 | Example 9 | Example 10 | Example 11 |
|---|---|---|---|---|---|---|---|---|
| Pellet | Component (I) | Component (I-i) | Mass % | — | — | — | — | — |
| | | Component (I-ii) | Mass % | 80 | 90 | 90 | 90 | 90 |
| | Component (II) | Component (II-i) | Mass % | — | 10 | — | — | — |
| | | Component (II-ii) | Mass % | 20 | — | 10 | 10 | 10 |
| | | Component (II-x-ii) | Mass % | — | — | — | — | — |
| | | Component (II-x-ii) | Mass % | — | — | — | — | — |
| Method | Screw configuration | | | 1 | 1 | 1 | 1 | 1 |
| for | Barrel | Barrel 1 | ° C. | 320 | 320 | 320 | 320 | 320 |
| producing | temprature | Barrel 2 | ° C. | 320 | 320 | 320 | 320 | 320 |
| pellet | | Barrel 3 | ° C. | 320 | 320 | 320 | 320 | 320 |
| | | Barrel 4 | ° C. | 320 | 320 | 320 | 320 | 320 |
| | | Barrel 5 | ° C. | 320 | 320 | 320 | 320 | 320 |
| | | Barrel 6 | ° C. | 320 | 320 | 320 | 320 | 320 |
| | | Barrel 7 | ° C. | 320 | 320 | 320 | 320 | 320 |
| | | Barrel 8 | ° C. | 320 | 320 | 320 | 320 | 320 |
| | | Barrel 9 | ° C. | 270 | 270 | 270 | 270 | 270 |
| | | Barrel 10 | ° C. | 270 | 270 | 270 | 270 | 270 |
| | | Barrel 11 | ° C. | 270 | 270 | 270 | 270 | 270 |
| | | Barrel 12 | ° C. | 270 | 270 | 270 | 270 | 270 |
| | | Barrel 13 | ° C. | 270 | 270 | 270 | 270 | 270 |
| | Nitrogen flow to atmospheric open vent | | Presence/ | Presence | Presence | Presence | Absence | Presence |
| | | | Absence | | | | | |
| | Screw rotation number | | rpm | 275 | 275 | 275 | 275 | 275 |
| | Oxygen concentration in the collecting hopper on the | | Volume % | 0.5 | 0.5 | 0.5 | 0.5 | 2.5 |
| | uppermost stream side | | | | | | | |
| Evaluation | (1) | Longitudinal diameter more than | Number | 0 | 0 | 0 | 0 | 0 |
| | Longitudinal | 0.7 mm | | | | | | |
| | diameter and number | Longitudinal diameter more than | Number | 0 | 0 | 1 | 5 | 2 |
| | of black spot foreign | 0.5 mm and 0.7 mm or less | | | | | | |
| | matters | Longitudinal diameter more than | Number | 2 | 2 | 4 | 15 | 6 |
| | | 0.3 mm and 0.5 mm or less | | | | | | |
| | | Evaluation of appearance | | Excellent | Excellent | Excellent | Good | Excellent |
| | (2) | Creeping performances of | Strain % | 20 | 17 | 18 | 21 | 18 |
| | Modification | modified PE: production | | | | | | |
| | performances of PE | method (A) | | | | | | |
| | | Creeping performances of | Strain % | 27 | 24 | 23 | 23 | 23 |
| | | modified PE: production | | | | | | |
| | | method (B) | | | | | | |
| | (3) | Vent-up from the atmospheric | Presence/ | Absence | Absence | Absence | Absence | Absence |
| | Production stability | open vent | Absence | | | | | |
| | | Discharge amount | kg/h | 300 | 300 | 300 | 300 | 300 |

| | | | | Example 12 | Example 13 | Example 14 | Example 15 | Example 16 |
|---|---|---|---|---|---|---|---|---|
| Pellet | Component (I) | Component (I-i) | Mass % | — | — | — | — | — |
| | | Component (I-ii) | Mass % | 90 | 90 | 90 | 90 | 90 |
| | Component (II) | Component (II-i) | Mass % | — | — | — | — | — |
| | | Component (II-ii) | Mass % | 10 | 10 | 10 | 10 | 10 |
| | | Component (II-x-ii) | Mass % | — | — | — | — | — |
| | | Component (II-x-ii) | Mass % | — | — | — | — | — |
| Method | Screw configuration | | | 1 | 2 | 4 | 5 | 1 |
| for | Barrel | Barrel 1 | ° C. | 320 | 320 | 320 | 320 | 290 |
| producing | temprature | Barrel 2 | ° C. | 320 | 320 | 320 | 320 | 290 |
| pellet | | Barrel 3 | ° C. | 320 | 320 | 320 | 320 | 290 |
| | | Barrel 4 | ° C. | 320 | 320 | 320 | 320 | 290 |
| | | Barrel 5 | ° C. | 320 | 320 | 320 | 320 | 290 |
| | | Barrel 6 | ° C. | 320 | 320 | 320 | 270 | 290 |
| | | Barrel 7 | ° C. | 320 | 320 | 320 | 270 | 290 |
| | | Barrel 8 | ° C. | 320 | 320 | 320 | 270 | 290 |
| | | Barrel 9 | ° C. | 270 | 270 | 270 | 270 | 270 |
| | | Barrel 10 | ° C. | 270 | 270 | 270 | 270 | 270 |
| | | Barrel 11 | ° C. | 270 | 270 | 270 | 270 | 270 |
| | | Barrel 12 | ° C. | 270 | 270 | 270 | 270 | 270 |
| | | Barrel 13 | ° C. | 270 | 270 | 270 | 270 | 270 |
| | Nitrogen flow to atmospheric open vent | | Presence/ | Presence | Presence | — | Presence | Presence |
| | | | Absence | | | | | |
| | Screw rotation number | | rpm | 275 | 275 | 185 | 275 | 275 |
| | Oxygen concentration in the collecting hopper on the | | Volume % | 3.5 | 0.5 | 0.5 | 0.5 | 0.5 |
| | uppermost stream side | | | | | | | |
| Evaluation | (1) | Longitudinal diameter more than | Number | 0 | 0 | 0 | 0 | 0 |
| | Longitudinal | 0.7 mm | | | | | | |
| | diameter and | Longitudinal diameter more than | Number | 3 | 0 | 0 | 1 | 0 |
| | number of black | 0.5 mm and 0.7 mm or less | | | | | | |
| | spot foreign matters | Longitudinal diameter more than | Number | 13 | 4 | 3 | 4 | 5 |
| | | 0.3 mm and 0.5 mm or less | | | | | | |
| | | Evaluation of appearance | | Good | Excellent | Excellent | Excellent | Excellent |
| | (2) | Creeping performances of | Strain % | 20 | 20 | 16 | 20 | 17 |
| | Modification | modified PE: production | | | | | | |
| | performances of PE | method (A) | | | | | | |
| | | Creeping performances of | Strain % | 23 | 23 | 23 | 23 | 23 |
| | | modified PE: production | | | | | | |
| | | method (B) | | | | | | |
| | (3) | Vent-up from the atmospheric | Presence/ | Absence | Presence*¹⁾ | — | Presence*¹⁾ | Presence*¹⁾ |
| | Production stability | open vent | Absence | | | | | |
| | | Discharge amount | kg/h | 300 | 300 | 200 | 300 | 300 |

^{*1)}The state where unmelted PPE powder is blown out from the opening portion

TABLE 3

| | | | | | | | Comparative | Comparative |
|---|---|---|---|---|---|---|---|---|
| | | | | Example 17 | Example 18 | Example 19 | Example 1 | Example 2 |
| Pellet | Component (I) | Component (I-i) | Mass % | — | — | — | 55 | 99.5 |
| | | Component (I-ii) | Mass % | 90 | 95 | 99 | — | — |
| | Component (II) | Component (II-i) | Mass % | — | — | — | 45 | 0.5 |
| | | Component (II-ii) | Mass % | 10 | 5 | 1 | — | — |
| | | Component (II-x-i) | Mass % | — | — | — | — | — |
| | | Component (II-x-ii) | Mass % | — | — | — | — | — |
| Method | Screw configuration | | | 1 | 1 | 1 | 1 | 1 |
| for | Barrel | Barrel 1 | ° C. | 320 | 320 | 320 | 320 | 320 |
| producing | temprature | Barrel 2 | ° C. | 320 | 320 | 320 | 320 | 320 |
| pellet | | Barrel 3 | ° C. | 320 | 320 | 320 | 320 | 320 |
| | | Barrel 4 | ° C. | 320 | 320 | 320 | 320 | 320 |
| | | Barrel 5 | ° C. | 320 | 320 | 320 | 320 | 320 |
| | | Barrel 6 | ° C. | 320 | 320 | 320 | 320 | 320 |
| | | Barrel 7 | ° C. | 320 | 320 | 320 | 320 | 320 |
| | | Barrel 8 | ° C. | 320 | 320 | 320 | 320 | 320 |
| | | Barrel 9 | ° C. | 270 | 270 | 270 | 270 | 270 |
| | | Barrel 10 | ° C. | 270 | 270 | 270 | 270 | 270 |
| | | Barrel 11 | ° C. | 270 | 270 | 270 | 270 | 270 |
| | | Barrel 12 | ° C. | 270 | 270 | 270 | 270 | 270 |
| | | Barrel 13 | ° C. | 270 | 270 | 270 | 270 | 270 |
| | Nitrogen flow to atmospheric open vent | | Presence/ | Presence | Presence | Presence | Presence | Presence |
| | | | Absence | | | | | |
| | Screw rotation number | | rpm | 300 | 275 | 300 | 230 | 230 |
| | Oxygen concentration in the collecting hopper on the | | Volume % | 0.5 | 0.5 | 0.5 | 0.5 | 0.5 |
| | uppermost stream side | | | | | | | |
| Evaluation | (1) | Longitudinal diameter more than | Number | 0 | 0 | 0 | 0 | 5 |
| | Longitudinal | 0.7 mm | | | | | | |
| | diameter and | Longitudinal diameter more than | Number | 0 | 0 | 4 | 0 | 14 |
| | number of black | 0.5 mm and 0.7 mm or less | | | | | | |
| | spot foreign matters | Longitudinal diameter more than | Number | 2 | 4 | 6 | 1 | 20 |
| | | 0.3 mm and 0.5 mm or less | | | | | | |
| | | Evaluation of appearance | | Excellent | Excellent | Excellent | Excellent | Poor |
| | (2) | Creeping performances of | Strain % | 16 | 13 | 12 | 48 | 12 |
| | Modification | modified PE: production | | | | | | |
| | performances of PE | method (A) | | | | | | |
| | | Creeping performances of | Strain % | 23 | 20 | 20 | 62 | 9 |
| | | modified PE: production | | | | | | |
| | | method (B) | | | | | | |
| | (3) | Vent-up from the atmospheric | Presence/ | Absence | Absence | Absence | Absence | Absence |
| | Production stability | open vent | Absence | | | | | |
| | | Discharge amount | kg/h | 325 | 300 | 275 | 250 | 250 |
| | | | | Comparative | Comparative | Comparative | Comparative | Comparative |
| | | | | Example 3 | Example 4 | Example 5 | Example 6 | Example 7 |
| Pellet | Component (I) | Component (I-i) | Mass % | 90 | — | — | — | — |
| | | Component (I-ii) | Mass % | — | 55 | 55 | 99.5 | 99.5 |
| | Component (II) | Component (II-i) | Mass % | — | 45 | — | 0.5 | — |
| | | Component (II-ii) | Mass % | — | — | 45 | — | 0.5 |
| | | Component (II-x-i) | Mass % | 10 | — | — | — | — |
| | | Component (II-x-ii) | Mass % | — | — | — | — | — |
| Method | Screw configuration | | | 1 | 1 | 1 | 1 | 1 |
| for | Barrel | Barrel 1 | ° C. | 320 | 320 | 320 | 320 | 320 |
| producing | temprature | Barrel 2 | ° C. | 320 | 320 | 320 | 320 | 320 |
| pellet | | Barrel 3 | ° C. | 320 | 320 | 320 | 320 | 320 |
| | | Barrel 4 | ° C. | 320 | 320 | 320 | 320 | 320 |
| | | Barrel 5 | ° C. | 320 | 320 | 320 | 320 | 320 |
| | | Barrel 6 | ° C. | 320 | 320 | 320 | 320 | 320 |
| | | Barrel 7 | ° C. | 320 | 320 | 320 | 320 | 320 |
| | | Barrel 8 | ° C. | 320 | 320 | 320 | 320 | 320 |
| | | Barrel 9 | ° C. | 270 | 270 | 270 | 270 | 270 |
| | | Barrel 10 | ° C. | 270 | 270 | 270 | 270 | 270 |
| | | Barrel 11 | ° C. | 270 | 270 | 270 | 270 | 270 |
| | | Barrel 12 | ° C. | 270 | 270 | 270 | 270 | 270 |
| | | Barrel 13 | ° C. | 270 | 270 | 270 | 270 | 270 |
| | Nitrogen flow to atmospheric open vent | | Presence/ | Presence | Presence | Presence | Presence | Presence |
| | | | Absence | | | | | |
| | Screw rotation number | | rpm | 230 | 275 | 275 | 275 | 275 |
| | Oxygen concentration in the collecting hopper on the | | Volume % | 0.5 | 0.5 | 0.5 | 0.5 | 0.5 |
| | uppermost stream side | | | | | | | |
| Evaluation | (1) | Longitudinal diameter more than | Number | 0 | 0 | 0 | 6 | 5 |
| | Longitudinal | 0.7 mm | | | | | | |
| | diameter and | Longitudinal diameter more than | Number | 1 | 0 | 0 | 14 | 13 |
| | number of black | 0.5 mm and 0.7 mm or less | | | | | | |
| | spot foreign matters | Longitudinal diameter more than | Number | 3 | 1 | 1 | 21 | 19 |
| | | 0.3 mm and 0.5 mm or less | | | | | | |
| | | Evaluation of appearance | | Excellent | Excellent | Excellent | Poor | Poor |
| | (2) | Creeping performances of | Strain % | 26 | 44 | 43 | 12 | 11 |
| | Modification | modified PE: production | | | | | | |
| | performances of PE | method (A) | | | | | | |
| | | Creeping performances of | Strain % | 37 | 60 | 58 | 8 | 7 |
| | | modified PE: production | | | | | | |
| | | method (B) | | | | | | |
| | (3) | Vent-up from the atmospheric | Presence/ | Absence | Absence | Absence | Absence | Absence |
| | Production stability | open vent | Absence | | | | | |
| | | Discharge amount | kg/h | 250 | 300 | 300 | 300 | 300 |
| | | | | Comparative | Comparative | Comparative | Comparative | Comparative |
| | | | | Example 8 | Example 9 | Example 10 | Example 11 | Example 12 |
| Pellet | Component (I) | Component (I-i) | Mass % | — | — | — | — | — |
| | | Component (I-ii) | Mass % | 80 | 90 | 95 | 90 | 90 |
| | Component (II) | Component (II-i) | Mass % | — | — | — | 10 | 10 |
| | | Component (II-ii) | Mass % | — | — | — | — | — |
| | | Component (II-x-i) | Mass % | 20 | 10 | 5 | — | — |
| | | Component (II-x-ii) | Mass % | — | — | — | — | — |
| Method | Screw configuration | | | 1 | 1 | 1 | 3 | 3 |
| for | Barrel | Barrel 1 | ° C. | 320 | 320 | 320 | 320 | 320 |
| producing | temprature | Barrel 2 | ° C. | 320 | 320 | 320 | 320 | 320 |
| pellet | | Barrel 3 | ° C. | 320 | 320 | 320 | 320 | 320 |
| | | Barrel 4 | ° C. | 320 | 320 | 320 | 320 | 320 |
| | | Barrel 5 | ° C. | 320 | 320 | 320 | 320 | 320 |
| | | Barrel 6 | ° C. | 320 | 320 | 320 | 320 | 320 |
| | | Barrel 7 | ° C. | 320 | 320 | 320 | 320 | 320 |
| | | Barrel 8 | ° C. | 320 | 320 | 320 | 320 | 320 |
| | | Barrel 9 | ° C. | 270 | 270 | 270 | 270 | 270 |
| | | Barrel 10 | ° C. | 270 | 270 | 270 | 270 | 270 |
| | | Barrel 11 | ° C. | 270 | 270 | 270 | 270 | 270 |
| | | Barrel 12 | ° C. | 270 | 270 | 270 | 270 | 270 |
| | | Barrel 13 | ° C. | 270 | 270 | 270 | 270 | 270 |
| | Nitrogen flow to atmospheric open vent | | Presence/ | Presence | Presence | Presence | Presence | Presence |
| | | | Absence | | | | | |
| | Screw rotation number | | rpm | 275 | 275 | 275 | 185 | 275 |
| | Oxygen concentration in the collecting hopper on the | | Volume % | 0.5 | 0.5 | 0.5 | 0.5 | 0.5 |
| | uppermost stream side | | | | | | | |
| Evaluation | (1) | Longitudinal diameter more than | Number | 0 | 0 | 0 | 1 | 5 |
| | Longitudinal | 0.7 mm | | | | | | |
| | diameter and | Longitudinal diameter more than | Number | 0 | 0 | 0 | 4 | 10 |
| | number of black | 0.5 mm and 0.7 mm or less | | | | | | |
| | spot foreign matters | Longitudinal diameter more than | Number | 2 | 3 | 3 | 4 | 13 |
| | | 0.3 mm and 0.5 mm or less | | | | | | |
| | | Evaluation of appearance | | Excellent | Excellent | Excellent | Poor | Poor |
| | (2) | Creeping performances of | Strain % | 47 | 40 | 36 | 29 | 41 |
| | Modification | modified PE: production | | | | | | |
| | performances of PE | method (A) | | | | | | |
| | | Creeping performances of | Strain % | 51 | 44 | 40 | 24 | 24 |
| | | modified PE: production | | | | | | |
| | | method (B) | | | | | | |
| | (3) | Vent-up from the atmospheric | Presence/ | Absence | Absence | Absence | Absence | Absence |
| | Production stability | open vent | Absence | | | | | |
| | | Discharge amount | kg/h | 300 | 300 | 300 | 200 | 300 |

| | | | | Comparative | Comparative |
|---|---|---|---|---|---|
| | | | | Example 13 | Example 14 |
| Pellet | Component (I) | Component (I-i) | Mass % | — | 60 |
| | | Component (I-ii) | Mass % | 90 | — |
| | Component (II) | Component (II-i) | Mass % | 10 | — |
| | | Component (II-ii) | Mass % | — | — |
| | | Component (II-x-i) | Mass % | — | — |
| | | Component (II-x-ii) | Mass % | — | 40 |
| Method | Screw configuration | | | 6 | 1 |
| for | Barrel | Barrel 1 | ° C. | 320 | 320 |
| producing | temprature | Barrel 2 | ° C. | 320 | 320 |
| pellet | | Barrel 3 | ° C. | 320 | 320 |
| | | Barrel 4 | ° C. | 320 | 320 |
| | | Barrel 5 | ° C. | 320 | 320 |
| | | Barrel 6 | ° C. | 320 | 320 |
| | | Barrel 7 | ° C. | 320 | 320 |
| | | Barrel 8 | ° C. | 320 | 320 |
| | | Barrel 9 | ° C. | 320 | 270 |
| | | Barrel 10 | ° C. | 320 | 270 |
| | | Barrel 11 | ° C. | 270 | 270 |
| | | Barrel 12 | ° C. | 270 | 270 |
| | | Barrel 13 | ° C. | 270 | 270 |
| | Nitrogen flow to atmospheric open vent | | Presence/ | Presence | Presence |
| | | | Absence | | |
| | Screw rotation number | | rpm | 275 | 230 |
| | Oxygen concentration in the collecting hopper on the | | Volume % | 0.5 | 0.5 |
| | uppermost stream side | | | | |
| Evaluation | (1) | Longitudinal diameter more than | Number | 4 | 5 |
| | Longitudinal | 0.7 mm | | | |
| | diameter and number | Longitudinal diameter more than | Number | 9 | 8 |
| | of black spot foreign | 0.5 mm and 0.7 mm or less | | | |
| | matters | Longitudinal diameter more than | Number | 14 | 17 |
| | | 0.3 mm and 0.5 mm or less | | | |
| | | Evaluation of appearance | | Poor | Poor |
| | (2) | Creeping performances of | Strain % | 39 | 42 |
| | Modification | modified PE: production | | | |
| | performances of PE | method (A) | | | |
| | | Creeping performances of | Strain % | 24 | 45 |
| | | modified PE: production | | | |
| | | method (B) | | | |
| | (3) | Vent-up from the atmospheric | Presence/ | Absence | Absence |
| | Production stability | open vent | Absence | | |
| | | Discharge amount | kg/h | 300 | 250 |

As shown in Table 2 and Table 3, as compared to the pellets of comparative examples 1 to 14, the pellets of Examples 1 to 19 had less black spot foreign matters, and were excellent in the modification properties of polyethylene.

In evaluation of the modification properties of polyethylene, the polyethylene modified with the production method (A) by using the pellet had components for improving the compatibility with polyethylene finely dispersed in the pellet, and thus was excellent in creep resistance. On the other hand, the polyethylene modified with the production method (B) did not obtain sufficient dispersibility, and had worse effect of creep resistance improvement.

### INDUSTRIAL APPLICABILITY

According to the present embodiment, it is possible to provide a pellet containing a polyphenylene ether resin at a high concentration, which is optimum for modifying polyethylene by providing creep resistance, and is excellent in appearance after molding; and to provide a method for producing the same.

1. A pellet comprising:
60 to 99 mass % of a polyphenylene ether resin (I); and
1 to 40 mass % of a block copolymer (II), which comprises a polymer block P mainly comprising a vinyl aromatic compound, and a polymer block Q mainly comprising a conjugated diene compound of which a total amount of 1,2-vinyl bonding amount and 3,4-vinyl bonding amount is 5% or more and less than 50%, wherein:
black spot foreign matters with a longitudinal diameter of more than 0.7 mm do not exist on front and back surfaces of four flat plates obtained by molding the pellet into the flat plates with a size of 90.0 mm×50.0 mm×2.0 mm.

2. The pellet according to claim 1, wherein: on front and back surfaces of the four flat plates, a number of observed black spot foreign matters with a longitudinal diameter of more than 0.5 mm and 0.7 mm or less is 5 or less.

3. The pellet according to claim 1, wherein: on front and back surfaces of the four flat plates, a number of observed black spot foreign matters with a longitudinal diameter of more than 0.3 mm and 0.5 mm or less is 10 or less.

4. The pellet according to claim 1, comprising:
80 to 99 mass % of the polyphenylene ether resin (I); and
1 to 20 mass % of the block copolymer (II).

5. The pellet according to claim 1, wherein: a number average molecular weight of the polymer block P is 15,000 or more.

6. The pellet according to claim 1, wherein: the total amount of 1,2-vinyl bonding amount and 3,4-vinyl bonding amount of the conjugated diene compound in the polymer block Q is 5% to 30%.

7. A method for producing a pellet, comprising: producing, by melt kneading with a twin screw extruder, a mixture comprising:
60 to 99 mass % of a polyphenylene ether resin (I); and
1 to 40 mass % of a block copolymer (II), which contains a polymer block P mainly comprising a vinyl aromatic compound, and a polymer block Q mainly comprising a conjugated diene compound of which a total amount of 1,2-vinyl bonding amount and 3,4-vinyl bonding amount is 5% or more and less than 50%, wherein:
in a flow direction of the mixture in the twin screw extruder, an oxygen concentration inside a material feed hopper located at an uppermost stream position is less than 3 volume %.

8. The method for producing a pellet according to claim 7, wherein:
the twin screw extruder has a first kneading zone and a second kneading zone, and
has at least two vents on a downstream side of the first kneading zone, at least one among the vents being a gas releasing atmospheric open vent.

9. The method for producing a pellet according to claim 8, wherein: a screw of the first kneading zone contains at least one orthogonal screw element, without containing pressure-up screw elements.

10. The method for producing a pellet according to claim 8, wherein: a screw of the second kneading zone contains at least one pressure-up screw element.

11. The method for producing a pellet according to claim 8, wherein: the gas releasing atmospheric open vent portion is filled with an inactive gas.

12. The method for producing a pellet according to claim 8, wherein: in the flow direction of the mixture in the twin screw extruder, a barrel set temperature from a barrel on an uppermost stream side to a barrel on which the gas releasing atmospheric open vent is disposed is 300° C. or more.

13. A resin modifier comprising the pellet according to claim 1.

14. A thermoplastic resin composition comprising the resin modifier according to claim 13.
